(19) United States
(12) Patent Application Publication
(10) Pub. No.: US 2021/0081590 A1
(43) Pub. Date: Mar. 18, 2021

(54) SYSTEM LEVEL SIMULATION AND EVALUATION OF CAPACITIVE AND INDUCTIVE SENSING-BASED SOLUTIONS

(71) Applicant: Cypress Semiconductor Corporation, San Jose, CA (US)

(72) Inventor: Vibheesh Bharathan, San Jose, CA (US)

(73) Assignee: Cypress Semiconductor Corporation, San Jose, CA (US)

(21) Appl. No.: 16/903,217

(22) Filed: Jun. 16, 2020

Related U.S. Application Data
(60) Provisional application No. 62/899,362, filed on Sep. 12, 2019.

(51) Int. Cl. G06F 30/3308; G06F 30/367; G06F 30/39

(52) U.S. Cl. CPC G06F 30/3308; G06F 3/044; G06F 30/39; G06F 30/367

(57) ABSTRACT

Information associated with a plurality of components of a capacitance sensing system is received. Performance of the capacitance sensing system is simulated based on the information associated with the plurality of components of the capacitance sensing system. A set of configuration parameters for a capacitance sensing controller is generated without user intervention based on the simulated performance of the capacitance sensing system.

### RELATED APPLICATIONS

This application claims priority to U.S. Provisional Patent Application No. 62/899,362, filed on Sep. 12, 2019, the disclosure of which is hereby incorporated herein in its entirety.

### TECHNICAL FIELD

The present disclosure relates generally to sensing systems, and more particularly to system level simulation and evaluation of capacitive and inductive sensing-based solutions and radio frequency communication systems.

### BACKGROUND

Capacitance sensing systems can sense electrical signals generated on electrodes that reflect changes in capacitance. For example, when a conductive object (e.g., a finger, hand, or other object) comes into contact or close proximity with a capacitive sense element, the capacitance changes and the conductive object is detected. Such changes in capacitance can indicate a touch event (i.e., the proximity of an object to particular electrodes). The capacitance changes can be measured by an electrical circuit that converts the signals corresponding to measured capacitances of the capacitive sense elements into digital values. The measured capacitances are generally received as currents or voltages that are integrated and converted to the digital values.

Capacitive sense elements may be used to replace mechanical buttons, dials/knobs, and other similar mechanical user interface controls. The use of such sense elements may replace the functionality of complicated mechanical switches and buttons, while providing reliable operation under harsh conditions. In addition, these sense elements are widely used in modern customer applications to provide user interface options in existing products. These sense elements can range from a single button to a large number arranged in the form of a capacitive sense array for a touch-sensing surface.

Sense arrays and touch buttons are ubiquitous in today's industrial and consumer markets. They can be found on cellular phones, GPS devices, set-top boxes, cameras, computer screens, MP3 players, digital tablets, and the like.

### BRIEF DESCRIPTION OF THE DRAWINGS

The present embodiments are illustrated by way of example, and not of limitation, in the figures of the accompanying drawings.

FIG. 1 is an illustration of a system simulator to simulate performance of a sensing system, in accordance with embodiments of the disclosure.

FIG. 2 is a block diagram illustrating a capacitive sensing system, according to some embodiments of the present disclosure.

FIG. 3 is a flow diagram of a method of generating configuration parameters based on the simulation of a capacitance sensing system, in accordance with some embodiments.

FIG. 4 is a flow diagram of a method of determining whether a capacitance sensing system meets a design requirement, in accordance with some embodiments.

FIG. 5 is a block diagram of an example computing device that may perform one or more of the operations described herein, in accordance with some embodiments.

### DETAILED DESCRIPTION

In the following description, for purposes of explanation, numerous specific details are set forth in order to provide a thorough understanding of the present embodiments. It will be evident, however, to one skilled in the art that the present embodiments may be practiced without these specific details. In other instances, well-known circuits, structures, and techniques are not shown in detail, but rather in a block diagram in order to avoid unnecessarily obscuring an understanding of this description.

Reference in the description to “one embodiment” or “an embodiment” means that a particular feature, structure, or characteristic described in connection with the embodiment is included in at least one embodiment. The phrase “in one embodiment” located in various places in this description does not necessarily refer to the same embodiment.

The performance and behavior of a sensing system design, such as a capacitance sensing system or inductive sensing system, is greatly dependent on a sensing circuit which is inside a chip as well as many system level design parameters. The performance and behavior of a radio frequency (RF) communication system may be dependent on other factors/parameters, such as antenna design, matching networks, connections, objects in proximity to the RF communication system, material(s) around the antenna, circuits/chips used by the RF communication system, and/or the physical design of the RF communication system.

In embodiments, the parameters may be characteristics of circuity inside of one or more chips of the sensing system. In an embodiment, the parameters may be geometry, type, material and/or size of capacitive sensors (also referred to as “sensors” hereafter). In some embodiments, the parameters may be a material, thickness, and/or stack up of an overlay (cover lens) and/or characteristics of a material that affects characteristics of the sensing system. In embodiments, the parameters may be types of objects in proximity to the sensors and a distance from the objects to the sensors. In an embodiment, the parameters may be a construction of a capacitive network around the sensor. In embodiments, the parameters may be characteristics of input signals that are being detected by the sensing system, such as finger size, type of touch (e.g., full touch or partial touch), etc. In some embodiments, the parameters may be firmware algorithm(s) used to detect signals or differentiate valid signals from noise. In embodiments, the parameters may be external and/or internal noise sources affecting the sensing system. In an embodiment, the parameters may be other systems located in proximity to the sensing system and how these systems may affect the sensing system.

The values for certain parameters of a sensing circuit, firmware algorithms, and/or software algorithms in a sensing controller (or an RF communication controller) are usually adjusted manually after physical construction of the hardware based on the behavior of the hardware, manufacturing variations, and/or use cases of a sensing system. The process of adjusting these parameters used by the sensing controller is also referred to as tuning.

When designing a sensing system, it is nearly impossible to estimate system performance before the sensing system is physically constructed. Without physically constructing the sensing system, it is difficult to identify the parameters for the sensing controller. Furthermore, it is difficult to estimate the performance of an integrated sensing system including multiple components, such as system hardware, mechanical stack ups, touch inputs, software/firmware, etc. without physically constructing the system. Additionally, it is difficult to identify key system parameters and configuration to optimize the performance of the sensing system, estimate impacts of external and internal noise sources, estimate impacts of process variations in manufacturing of the system components and/or adjust parameters to meet noise requirements without first physically constructing the sensing system.

Typically, the design of a sensing system requires multiple revisions before a design is finalized, where prototypes of each revision are physically constructed and tuned to identify configuration parameters for the sensing controller that are suitable for the design of the sensing system. This process demands time, the physical resources of constructing each prototype, and is fraught with errors.

The inability to estimate the performance and behavior of a design for a sensing system for physically constructing the system may result in delays in product development as the multiple revisions are being constructed. Furthermore, the inability may result in being unable to optimize the various components/parts of the sensing system to optimize the performance of the sensing system because the impact each of the components has on the overall performance of the sensing system is not clearly understood. Additionally, it is difficult to develop parameters, such as configuration parameters, that need to be programmed into a device portion of system firmware.

Furthermore, some organizations/associations may have recommendations or design rules for the design of sensing or inductive sensing systems. Typically, designs for sensing systems are manually reviewed to determine whether the design satisfies the recommendations or design rules. However, the manual review of designs is inefficient and susceptible to various process errors and human errors. Furthermore, to perform a manual review of the layout of the capacitance sensing system, the hardware of the sensing system must be physically constructed and therefore has the disadvantages described above.

While some conventional simulation tools may exist for various individual components of a sensing system, these tools cannot simulate the performance of a sensing system as a whole (e.g., a sensing system including multiple components). For example, a conventional simulation tool may be able to simulate the behavior of a component of a sensing system, such as a particular sensor pattern, but cannot simulate the behavior of multiple components of the sensing system.

Aspects of the disclosure remedy the above and other deficiencies by providing a system simulation tool (also referred to as “tool” hereafter) that can simulate/estimate the performance of a sensing system and its corresponding components without requiring the physical construction of the sensing system. The tool may extract information from various design files of the sensing system and other factors that influence the performance of the sensing system. The simulation utilizes design information from various components of the sensing system. Examples of components that may be utilized by the capacitance sensing system include, but are not limited to, firmware, software, algorithms, user configuration, hardware design, circuit information, mechanical construction, proximity to other systems or objectives, noise sources, manufacturing issues, or any other factors that influence the performance or behavior of the sensing system. With the design information, the performance of the sensing system is simulated to predict the end system performance before physical construction of the sensing system has occurred. Using the end system performance, the tool may generate a set of configuration parameters for a sensing controller to be used by the sensing system.

In embodiments, the tool may output an expected performance of the sensing system. In some embodiments, the tool may be used to estimate how each of the components of the sensing system affect the performance/behavior of the sensing system. In an embodiment, the tool may be used to optimize the components of the sensing system during the development phase of the sensing system. In embodiments, the tool may be utilized to identify problems early in the development phase to avoid delays and the construction of multiple prototypes/revisions of the sensing system. In some embodiments, the tool may be used to estimate the effect of internal and/or external circuits on the performance/behavior of the sensing system.

In embodiments, the tool may automatically check the design of the sensing system to verify whether the design satisfies one or more recommendations or design rules for the sensing system. In some embodiments, the tool may be used to optimize performance and/or behavior of the capacitance sensing system and/or components of the sensing system. In an embodiment, the tool may identify key requirements and/or performance requirements for various components of the sensing system, operation conditions and/or other dependencies of the sensing system. In some embodiments, the tool may be used to compensate for the behavior of the sensing system under different environmental conditions, use cases, operating conditions, product life cycles, etc.

Although examples in the disclosure may be described with respect to capacitance sensing systems, the embodiments of the present disclosure may be realized utilizing any appropriate sensing system (e.g., inductive, resistive). Furthermore, aspects of the disclosure may be utilized for the simulation of radio frequency (RF) antenna systems. For example, aspects of the disclosure may be utilized to simulate the performance of an RF antenna system based on receiving information associated with various components (e.g., RF antenna, chips, circuits, noise sources, etc.) of the RF antenna system. In another example, aspects of the disclosure may be utilized to generate a set of configuration parameters for a controller of the RF antenna system.

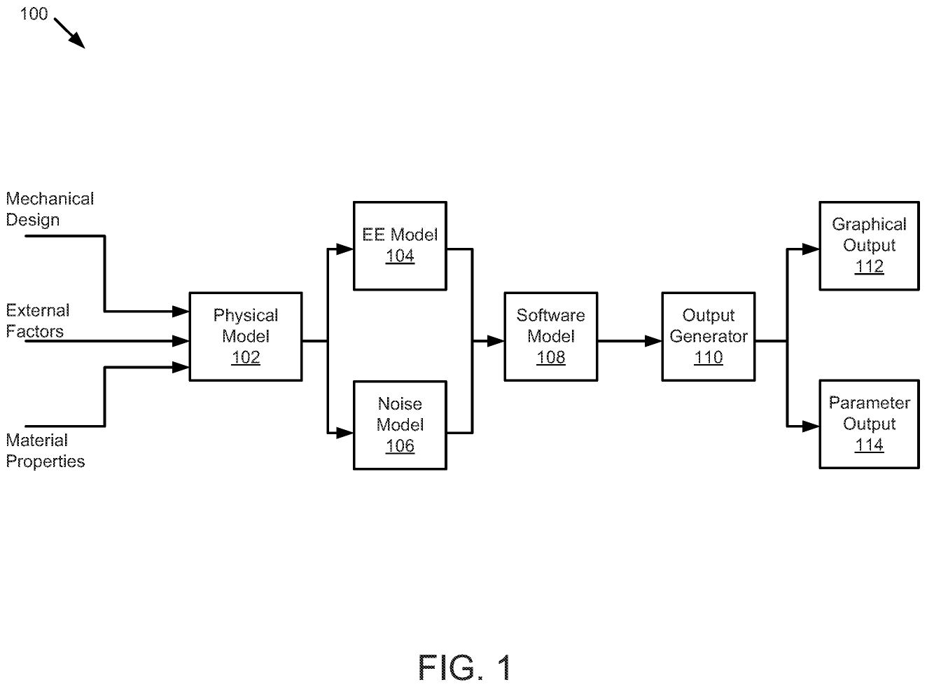

FIG. 1 is an illustration of a system simulator 100 to simulate performance of a sensing system, in accordance with embodiments of the disclosure. In embodiments, the system simulator 100 may be executed by processing logic of one or more processing devices (not shown), as will be described in further detail below. The system simulator may include a physical model 102, an electrical and electronics (EE) model 104, a noise model 106, a software model 108, an output generator 110, a graphical output 112, and/or a parameter output 114. It should be noted that the components of system simulator 100 are shown for illustrative purposes only. Embodiments of the system simulator 100 may utilize alternative combinations of components and/or additional components.

The system simulator 100 may receive mechanical design(s), external factor(s), and/or material properties associated with a capacitance sensing system. In embodiments, the system simulator 100 may provide a user interface to enable a user to provide information, such as the mechanical designs, external factors, and/or material properties, to the system simulator 100.

The mechanical design may correspond to one or more design files or information associated with the mechanical design of the capacitance sensing system. In an embodiment, the mechanical design may include a two-dimensional (2D) printed circuit board (PCB) design file, such as a source or Gerber file. In some embodiments, the mechanical design may include a 2D or three-dimensional (3D) mechanical drawing file, such as a design file generated by computer aided design (CAD) software. In embodiments, the mechanical design may include stack up information, such as a thickness or stack up of an overlay of the capacitance sensing system.

The material properties may correspond to one or more properties of materials involved in the construction of the capacitance sensing system. For example, the material properties may correspond to properties associated with the materials that make up the capacitive sensors, housings, stack ups, etc. of the capacitance sensing system.

The external factors may correspond to various factors external to the capacitance sensing system that may affect the performance or behavior of the capacitance sensing system. In embodiments, the external factors may include the dimensions and/or types of touch objects, such as a finger or stylus, that are to interact with the capacitive sensors of the capacitance sensing system. In an embodiment, the external factors may include electrical and non-electrical noise that may affect the capacitance sensing system. For example, the external factors may include noise caused by liquid or other influencing objects in proximity to the capacitance sensing system.

In embodiments, the system simulator 100 may utilize the external factors to in the simulation of multiple capacitance sensing systems. For example, the system simulator 100 may maintain a database of various external factors, such as external noise sources, touch object dimensions, etc., that may be used/reused in the simulation of different capacitance sensing systems.

In some embodiments, the system simulator 100 may receive one or more user configurable parameters (not shown). The user configurable parameters may be parameters defined by a user that influence the performance or behavior of one or more components of the capacitance sensing system or the capacitance sensing system as a whole.

The physical model 102 may import information related to the design of the capacitance sensing system. In embodiments, the physical model 102 may import design files, materials/material properties, external factors, etc. associated with a capacitance sensing system, as previously described. For example, the physical model 102 may extract sensor geometry by importing a PCB design file and system stack up information may be extracted by importing mechanical design files such as a CAD file. In embodiments, a user may manually enter specific key dimensions of the capacitance sensing system in addition to or instead of providing design files to the physical model 102. For example, a user may enter dimensions for a sensor geometry via a user interface.

Upon importing the information related to the design of the capacitance sensing system, the physical model 102 may generate a model of the design of the capacitance sensing system. For example, the physical model 102 may generate a 3D model of the capacitance sensing system. The physical model may extract electrical and/or non-electrical parameters that may be derived from the model and any material property information. Examples of electrical and non-electrical parameters that may be derived include, but are not limited to, capacitance, resistance, impedance, dielectric constants, or active/passive components in the circuit. In embodiments, the outputs of the physical model 102 may be provided to the EE model 104 and/or noise model 106.

The EE model 104 may produce an estimate output of electronic circuits that are connected with the design of the capacitance sensing system. In embodiments, the EE model 104 may use a model of a programmable system on a chip (PSoC), or sub-blocks within the PSoC, to produce the estimated output. In some embodiments, the EE model 104 may extract the chip and circuit level information from mathematical or Simulation Program with Integrated Circuit Emphasis (SPICE) models embedded into simulation tools for the various devices of the capacitance sensing system. In an embodiment, the EE model 104 may use other customized mathematical models. In embodiments, the EE model 104 may utilize capacitive sensing algorithms, such as Cypress CapSense® technology. In some embodiments, the EE model 104 may utilize inductive sensing algorithms, such as Cypress MagSense™ technology. In an embodiment, the EE model 104 may utilize RF sensing algorithms. In embodiments, the estimated outputs produced by the EE model 104 may include an analog-to-digital converter (ADC) result, an RF transmission, and/or a specific electrical signal.

The noise model 106 may include one or more models of internal noises of sub-modules within the chip of the sensing system or external noise factors that have been specified by a user that may disturb electronic signals of the sensing system. Examples of noise models may include, but are not limited to, conducted noise, radiated noise, cross talk noise, and other general noises. In some embodiments, the noise model 106 and EE model 104 may be configured in parallel with one another, as shown in FIG. 1. In other embodiments, the noise model 106 and the EE model 104 may be configured in series.

The software model 108 may include software and/or firmware that may be utilized by the capacitance sensing system. In embodiments, the software model 108 may include software and/or firmware algorithms that are used to process data output by the EE model 104 and/or the noise model 106. In some embodiments, the software model 108 may include software and/or firmware that is used to control and influence the performance/behavior of the hardware of the capacitance sensing system. Examples of software/firmware that may be included in the software model 108 include, but are not limited to, firmware filters, signal detection algorithms, frequency hopping algorithms, or other data processing algorithms.

The output generator 110 may generate an output from the simulation based on the physical model 102, the EE model 104, the noise model 106, and/or the software model 108. In an embodiment, the output generated by the output generator 110 may correspond to an expected performance of a physical construction the sensing system being simulated by the system simulator 100. In embodiments, the output generator 110 may provide the outputs using a graphical output 112 and/or a parameter output 114.

The graphical output 112 may correspond to a visual indication of the behavior/performance of the simulated sensing system. For example, the output generator 110 may provide one or more graphs to a user that illustrate the expected performance of the sensing system. In embodiments, the graphical output 112 may include a graphical user interface (GUI) that may receive inputs from a user to adjust inputs, parameters, configurations, etc., of the sensing system and analyze the impact of the adjustments on the performance of the sensing system. For example, the user may provide inputs via the GUI to adjust types of materials, chips, sensor parameters, etc. In response to receiving the inputs, the system simulator 100 may determine the expected performance of the sensing system using the adjusted inputs and provide the expected performance to the user. Accordingly, inputs of the system may be adjusted until a desired performance/behavior has been achieved to determine a configuration that optimizes the performance of the sensing system. These inputs may then be used to construct a physical sensing system that corresponds to the optimized configuration.

The parameter output 114 may correspond to a summary of information that is generated by the simulation of the sensing system that may be integrated into the sensing system. For example, the parameter output 114 may be values for a set of configuration parameters for hardware and/or firmware modules of the sensing system that may be stored in sensing system memory. In embodiments, the set of configuration parameters may be stored in the memory of a controller of the sensing system, as will be described in further detail below. In embodiments, the parameter output 114 may include design files and/or information related to the design of the sensing system. For example, the parameter output 114 may include design files and/or information that may be imported into design tools, such as a PCB layout tool.

By using system simulator 100, a user can estimate system performance prior to creating a physical construction of the sensing system. Users can identify an optimized combination of components for the sensing system that will meet design requirement prior to building the hardware of the sensing system. For example, users can change specific parameters, devices, external noises, sensor geometry, stack up, external factors, etc., and estimate the system performance in real-time using the interface of the system simulator 100. This allows users to identify an optimal combination of system components prior to creating a physical construction of the sensing system and embedded application firmware that may be downloaded into hardware and/or chip(s) of the sensing system.

In some embodiments, the system simulator 100 may be used to implement a sensor designer (not shown). The sensor designer may be an application that enables a user to design sensors for use in a sensing system. In embodiments, a user may not have all of the required input information for designing a sensor. Using the sensor designer, the user may provide any information that is available and estimate any other information required for the sensor design. The system simulator 100 may run a simulation on the sensor in real-time based on the inputs to determine an expected performance of the sensor. Parameters of the sensor design may be adjusted, either by the system simulator 100 or the user, until an optimal sensor design is identified that meets design requirements. The optimal sensor design may be exported to a CAD or PCB designer tool to create a design of a sensor stack up.

In embodiments, the system simulator 100 may be used to implement a design rule/requirement check (not shown). The system simulator 100 may integrate design guidelines, rules, requirements, etc. for the design of a sensing system. When a design of a sensing system is imported into the system simulator 100 and the simulation is run, the system simulator 100 may automatically check the sensing system design against these imported design requirements. In embodiments, the system simulator 100 may generate a report indicating any violations of the design requirements and/or propose recommended changes to the sensing system that improve system performance and/or enable the sensing system to meet the design requirements. Additional details with regards to the design requirement check will be discussed below.

In an embodiment, the system simulator 100 may be used for a parametric simulation. In a parametric simulation, a user may utilize the system simulator 100 to vary one or more parameters of the sensing system over a range of values and produce an output for the range of values. For example, a user may plot a graph showing a relationship between two or more ranges of parameters of the system and select a combination of parameters based on the values.

As previously described, the system simulator 100 may be used to simulate an RF antenna system. In embodiments, a user may provide a PCB design file after integrating an RF antenna into a system design. The design file may be imported into the system simulator 100. The system simulator 100 may run a simulation to determine expected performance characteristics and/or identify any potential issues in the design of the RF antenna system. Examples of expected performance characteristics may include, but aren't limited to, impedance mismatch, gain, or return loss.

In some embodiments, the system simulator 100 may be implemented as a standalone software application. In embodiments, the system simulator 100 may be integrated with other software applications. For example, the system simulator 100 may be integrated as part of an integrated development environment (IDE) or as part of a CAD design tool. In an embodiment, the system simulator 100 may be implemented as a web application. For example, the system simulator 100 may be hosted on a website, where a user can upload design files for the system simulator 100 to review without manual integration.

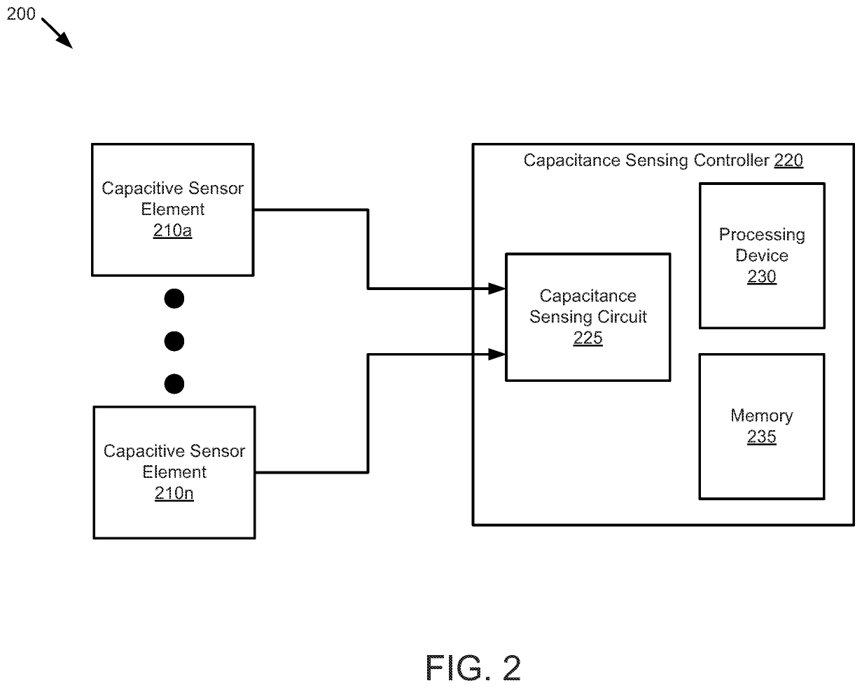

FIG. 2 is a block diagram illustrating one embodiment of a capacitance sensing system 200. The capacitance sensing system 200 may include capacitive sensor elements 210a-n and a capacitance sensing controller 220. Capacitive sensor elements 210a-n may correspond to one or more capacitive sensor elements of the capacitance sensing system 200. In embodiments, capacitive sensor elements 210a-n may correspond to an array of capacitive sensor elements.

The capacitance sensing controller 220 may be configured to measure capacitances (self or mutual capacitances) from the capacitive sensor elements 210a-n. In one embodiment, a multiplexer circuit may be used to connect a capacitance sensing circuit 225 of the capacitance sensing controller 220 with the capacitive sensor elements 210a-n in various configurations.

In embodiments, the capacitance sensing circuit 225 also includes a converter circuit, such an analog-to-digital converter (ADC) that converts the measured signals into digital values. The capacitance sensing controller 220 may further include software components to convert the count value (e.g., capacitance value) into a touch detection decision (also referred to as switch detection decision) or relative magnitude. It should be noted that there are various known methods for measuring capacitance, such as current versus voltage phase shift measurement, resistor-capacitor charge timing, capacitive bridge divider, charge transfer, successive approximation, sigma-delta modulators, charge-accumulation circuits, field effect, mutual capacitance, frequency shift, or other capacitance measurement algorithms. It should be noted however, in some embodiments, instead of evaluating the raw counts relative to a threshold, the capacitance sensing circuit 225 may be evaluating other measurements to determine the user interaction. For example, in the capacitance sensing circuit 225 having a sigma-delta modulator, the capacitance sensing circuit 225 is evaluating the ratio of pulse widths of the output (i.e., density domain), instead of the raw counts being over or under a certain threshold.

The capacitance sensing controller 220 is configured to detect one or more conductive objects in contact with or in proximity with the capacitive sensor elements 210a-n. As used herein, a “touch” may refer to a conductive object in contact with or in proximity to the capacitive sensor elements 210a-n. The capacitance sensing controller 220 can detect conductive objects, such as fingers or passive styluses, an active stylus, or any combination thereof. The capacitance sensing circuit 225 can measure touch data on the capacitive sensor elements 210a-n.

The capacitive sensor elements 210a-n are electrodes of conductive material, such as copper. The capacitive sensor elements 210a-n may also be part of a panel made from ITO or any other transparent or semi-transparent conductive material. The capacitive sensor elements 210a-n can be configurable to allow the capacitive sensing circuit 225 to measure self-capacitance, mutual capacitance, or any combination thereof. In another embodiment, the touch data is a 2D capacitive image of the capacitive sensor elements 210a-n. In one embodiment, when the capacitance sensing circuit 225 measures mutual capacitance of the touch-sensing device (e.g., capacitive sensor elements 210a-n), the capacitance sensing circuit 225 obtains a 2D capacitive image of the touch-sensing device and processes the data for peaks and positional information. In another embodiment, the capacitance sensing controller 220 is a microcontroller that obtains a capacitance touch signal data set, such as from the capacitive sensor elements 210a-n, and finger detection firmware executing on the microcontroller identifies data set areas that indicate touches, detects and processes peaks, calculates the coordinates, or any combination therefore. The firmware identifies the peaks using the embodiments described herein. The firmware can calculate a precise coordinate for the resulting peaks. In one embodiment, the firmware can calculate the precise coordinates for the resulting peaks using a correlation algorithm, which calculates a correlation coefficient of each possible angle, and identifies the angle having the highest correlation coefficient as the position of the touch. The X/Y coordinates of the peak may describe the exact position of the touch, as described in further detail herein. Alternatively, other coordinate interpolation algorithms may be used to determine the coordinates of the resulting peaks.

In one embodiment, the capacitance sensing controller 220 further includes processing device 230. Operations of the processing device 230 may be implemented in firmware; alternatively, they may be implemented in hardware or software. The processing device 230 may receive signals from the capacitance sensing circuit 225, and determine the state of the capacitive sensor elements 210a-n, such as whether an object (e.g., a finger) is detected on or in proximity to the capacitive sensor elements 210a-n (e.g., determining the presence of the object), resolve where the object is on the sense array (e.g., determining the location of the object), tracking the motion of the object, or other information related to an object detected at the touch sensor.

As illustrated, capacitance sensing circuit 225 may be integrated into capacitance sensing controller 220. Capacitance sensing circuit 225 may include analog I/O for coupling to an external component, such as touch-sensor pad (not shown), capacitive sensor elements 210a-n, touch-sensor slider (not shown), touch-sensor buttons (not shown), and/or other devices. The capacitance sensing circuit 225 may be configurable to measure capacitance using mutual-capacitance sensing techniques, self-capacitance sensing technique, charge coupling techniques, or the like. In one embodiment, capacitance sensing circuit 225 operates using a charge accumulation circuit, a capacitance modulation circuit, or other capacitance sensing methods known by those skilled in the art. In an embodiment, the capacitance sensing circuit 225 is of the Cypress TMA-4xx, or TMA-xx families of touch screen controllers. Alternatively, other capacitance sensing circuits may be used. The capacitive sense arrays, or touch screens, as described herein, may include a transparent, conductive sense array disposed on, in, or under either a visual display itself (e.g. LCD monitor), or a transparent substrate in front of the display.

The capacitance sensing controller 220 may reside on a common carrier substrate such as, for example, an integrated circuit (IC) die substrate, or a multi-chip module substrate. Alternatively, the components of the capacitance sensing controller 220 may be one or more separate integrated circuits and/or discrete components. In one embodiment, the capacitance sensing controller 220 may be the Programmable System on a Chip (PSoC®) processing device, developed by Cypress Semiconductor Corporation, San Jose, Calif. Alternatively, the capacitance sensing controller 220 may be one or more other processing devices known by those of ordinary skill in the art, such as a microprocessor or central processing unit, a controller, special-purpose processor, digital signal processor (DSP), an application specific integrated circuit (ASIC), a field programmable gate array (FPGA), or other programmable device. In an alternative embodiment, for example, the capacitance sensing controller 220 may be a network processor having multiple processors including a core unit and multiple micro-engines. Additionally, the capacitance sensing controller 220 may include any combination of general-purpose processing device(s) and special-purpose processing device(s).

Capacitance sensing circuit 225 may be integrated into the IC of capacitance sensing controller 220, or alternatively, in a separate IC. Alternatively, descriptions of capacitance sensing circuit 225 may be generated and compiled for incorporation into other integrated circuits. For example, behavioral level code describing the capacitance sensing circuit 225, or portions thereof, may be generated using a hardware descriptive language, such as VHDL or Verilog, and stored to a machine-accessible medium (e.g., CD-ROM, hard disk, floppy disk, etc.). Furthermore, the behavioral level code can be compiled into register transfer level (“RTL”) code, a netlist, or even a circuit layout and stored to a machine-accessible medium. The behavioral level code, the RTL code, the netlist, and the circuit layout may represent various levels of abstraction to describe capacitance sensing circuit 225.

The capacitance sensing controller 220 may further include a memory 235. In embodiments, memory 235 may include volatile memory devices (e.g., random access memory (RAM)), non-volatile memory devices (e.g., flash memory) and/or other types of memory devices.

It should be noted that the components of capacitance sensing system 200 may include all the components described above. Alternatively, capacitance sensing system 200 may include some of the components described above.

In one embodiment, the capacitance sensing system 200 is used in a tablet computer. Alternatively, the electronic device may be used in other applications, such as a notebook computer, a mobile handset, a personal data assistant (“PDA”), a keyboard, a television, a remote control, a monitor, a handheld multi-media device, a handheld media (audio and/or video) player, a handheld gaming device, a signature input device for point of sale transactions, an eBook reader, global position system (“GPS”) or a control panel. The embodiments described herein are not limited to touch screens or touch-sensor pads for notebook implementations, but can be used in other capacitive sensing implementations, for example, the sensing device may be a touch-sensor slider (not shown) or touch-sensor buttons (e.g., capacitance sensing buttons). In one embodiment, these sensing devices include one or more capacitive sensors or other types of capacitance sensing circuitry. The operations described herein are not limited to notebook pointer operations, but can include other operations, such as lighting control (dimmer), volume control, graphic equalizer control, speed control, or other control operations requiring gradual or discrete adjustments. It should also be noted that these embodiments of capacitive sensing implementations may be used in conjunction with non-capacitive sensing elements, including but not limited to pick buttons, sliders (ex. display brightness and contrast), scroll-wheels, multi-media control (ex. volume, track advance, etc.) handwriting recognition, and numeric keypad operation.

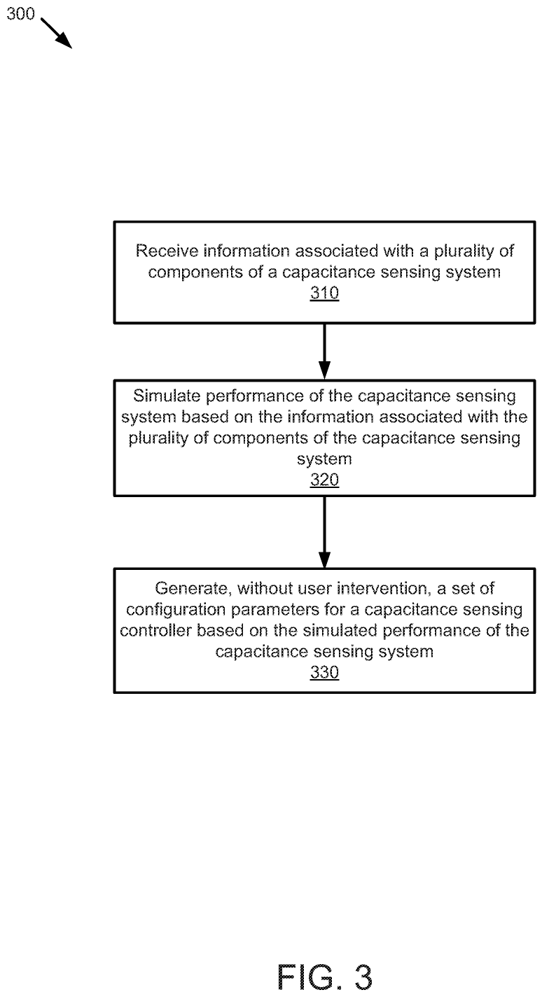

FIG. 3 is a flow diagram of a method 300 of generating configuration parameters based on the simulation of a capacitance sensing system, in accordance with some embodiments. Method 300 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. For example, the method 300 may be performed by processing logic executing system simulator 100 of FIG. 1.

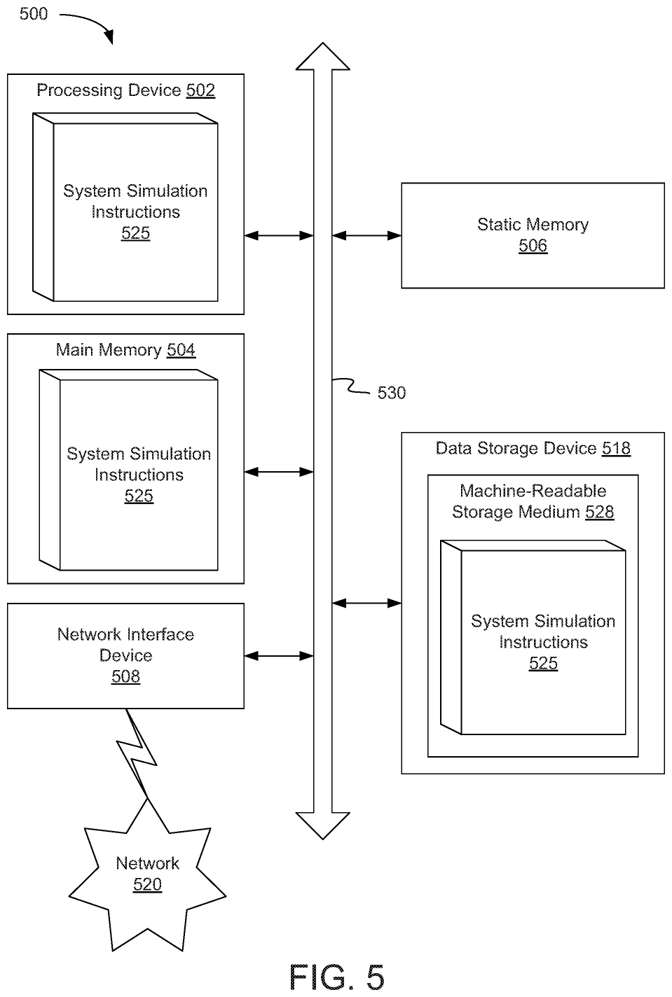

Method 300 begins at block 310, where the processing logic receives information associated with a plurality of components of a capacitance sensing system. In embodiments, the information associated with the plurality of components may correspond to noise models, device models, algorithm models, sensor design files, system design files, and/or other information associated with the capacitance sensing system, as previously described at FIG. 5.

At block 320, the processing logic simulates performance of the capacitance sensing system based on the information associated with the plurality of components of the capacitance sensing system.

At block 330, the processing logic generates, without user intervention, a set of configuration parameters for a capacitance sensing controller based on the simulated performance of the capacitance sensing system. For example, the processing logic may automatically generate the set of configuration parameters without requiring a user interaction/input with/to the processing logic. The set of configuration parameters may include one or more parameters for use by the capacitance sensing controller to satisfy the design requirements, rules, etc. of the capacitance sensing system. For example, the set of configuration parameters may include one or more parameters to enable the capacitance sensing controller to properly detect a touch at a capacitive sensor element. In embodiments, the set of configuration parameters may be downloaded and stored at a memory (e.g., memory 235 of FIG. 2) of the capacitance sensing controller (e.g., capacitance sensing controller 220 of FIG. 2).

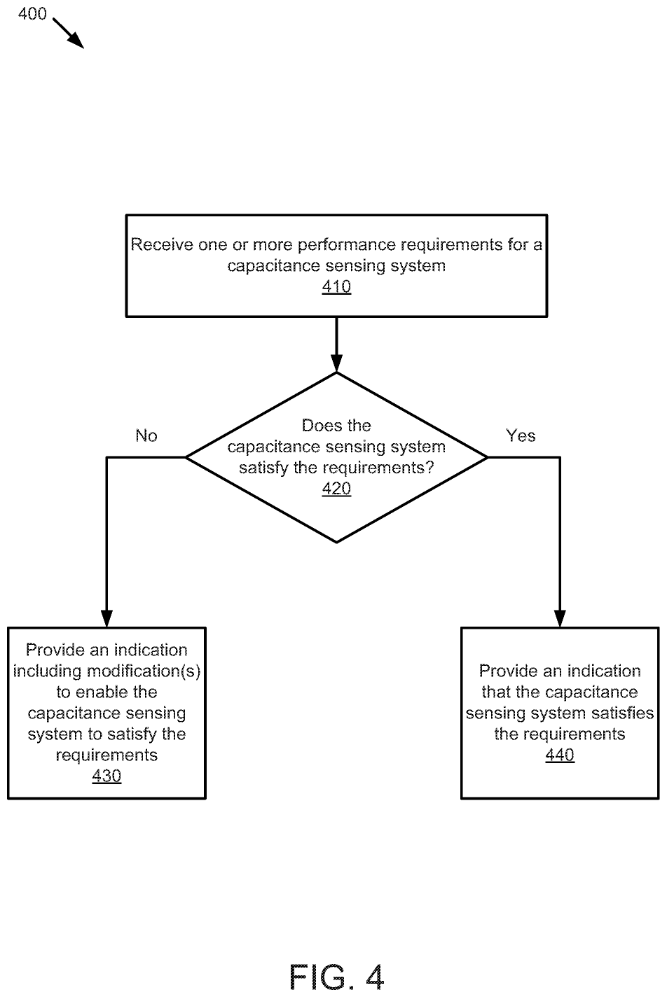

FIG. 4 is a flow diagram of a method 400 of determining whether a capacitance sensing system meets a design requirement, in accordance with some embodiments. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. For example, the method 400 may be performed by processing logic executing system simulator 100 of FIG. 1.

Method 400 begins at block 410, where the processing logic receives one or more performance requirements for a capacitance sensing system. As previously described, some organizations/associations may have recommendations or design rules for the design of capacitive sensing or inductive sensing systems. Accordingly, the one or more performance requirements may correspond to recommendations/design rules for the capacitance sensing system.

At block 420, the processing logic determines if the capacitance sensing system satisfies the one or more performance requirements for the capacitance sensing system. The processing logic may determine whether the capacitance sensing system satisfies the requirements by running a simulation of the capacitance sensing system, as previously described. The processing logic may use the results of the simulation to determine whether the capacitance sensing system satisfies the performance requirement(s) for the capacitance sensing system.

At block 430, if the processing logic determines that the capacitance sensing system does not satisfy the performance requirements, the processing logic may provide an indication that the capacitance sensing system does not satisfy the performance requirements. In some embodiments, the indication may be a notification indicating that the capacitance sensing system does not satisfy the performance requirements.

In embodiments, the indication may include one or more modifications that can be made to the capacitance sensing system to satisfy the performance requirements. For example, the processing logic may determine that a particular circuit, chip, capacitive sensing element property, etc., is causing the capacitance sensing system to not satisfy the performance requirements. Accordingly, the include modifications, such as selecting a different chip, altering a property of the capacitive sensing element, etc., that may enable the capacitance sensing system to satisfy the performance requirements.

At block 440, if the processing logic determines that the capacitance sensing system satisfies the performance requirements, the processing logic may provide an indication that the capacitance sensing system satisfies the performance requirements. For example, the processing logic may provide a notification indicating that the capacitance sensing system satisfies the performance requirements.

FIG. 5 is a block diagram of an example computing device 500 that may perform one or more of the operations described herein, in accordance with some embodiments. Computing device 500 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 500 may include a processing device (e.g., a general purpose processor, a PLD, etc.) 502, a main memory 504 (e.g., synchronous dynamic random access memory (DRAM), read-only memory (ROM)), a static memory 506 (e.g., flash memory and a data storage device 518), which may communicate with each other via a bus 530.

Processing device 502 may be provided by one or more general-purpose processing devices such as a microprocessor, central processing unit, or the like. In an illustrative example, processing device 502 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 502 may also comprise one or more special-purpose processing devices such as an application specific integrated circuit (ASIC), a field programmable gate array (FPGA), a digital signal processor (DSP), network processor, or the like. The processing device 502 may be configured to execute the operations described herein, in accordance with one or more aspects of the present disclosure, for performing the operations and steps discussed herein.

Computing device 500 may further include a network interface device 508 which may communicate with a network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 510, alphanumeric input device 512, and cursor control device 514 may be combined into a single component or device (e.g., an LCD touch screen).

Data storage device 518 may include a computer-readable storage medium 528 on which may be stored one or more sets of system simulation instructions 525 for carrying out the operations described herein, in accordance with one or more aspects of the present disclosure. System simulation instructions 525 may also reside, completely or at least partially, within main memory 504 and/or within processing device 502 during execution thereof by computing device 500, main memory 504 and processing device 502 also constituting computer-readable media. The system simulation instructions 525 may further be transmitted or received over a network 520 via network interface device 508.

While computer-readable storage medium 528 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

In the above description, numerous details are set forth. It will be apparent, however, to one of ordinary skill in the art having the benefit of this disclosure, that embodiments of the present disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “detecting,” “comparing,” “resetting,” “adding,” “calculating,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

Embodiments descried herein may also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions. The term “computer-readable storage medium” should be taken to include a single medium or multiple media (e.g., a centralized or distributed database and/or associated caches and servers) that store one or more sets of instructions. The term “computer-readable medium” shall also be taken to include any medium that is capable of storing, encoding, or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the embodiments as described herein.

The above description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present embodiments. Thus, the specific details set forth above are merely exemplary. Particular implementations may vary from these exemplary details and still be contemplated to be within the scope of the present embodiments.

It is to be understood that the above description is intended to be illustrative and not restrictive. Many other embodiments will be apparent to those of skill in the art upon reading and understanding the above description. The scope of the embodiments should, therefore, be determined with reference to the appended claims, along with the full scope of equivalents to which such claims are entitled.

What is claimed is:

1. A non-transitory computer-readable storage medium including instructions to simulate a capacitance sensing system that, when executed by a processing device, cause the processing device to:
receive information associated with a plurality of components of the capacitance sensing system;
simulate performance of the capacitance sensing system based on the information associated with the plurality of components of the capacitance sensing system; and
generate, by the processing device without user intervention, a set of configuration parameters for a capacitance sensing controller based on the simulated performance of the capacitance sensing system.

2. The non-transitory computer-readable storage medium of claim 1, wherein the information associated with the plurality of components comprises a mechanical design of the capacitance sensing system.

3. The non-transitory computer-readable storage medium of claim 1, wherein the information associated with the plurality of components comprises a user configuration of the capacitance sensing system.

4. The non-transitory computer-readable storage medium of claim 1, wherein the information associated with the plurality of components comprises a hardware design of the capacitance sensing system.

5. The non-transitory computer-readable storage medium of claim 1, wherein the information associated with the plurality of components comprises circuit information associated with the capacitance sensing system.

6. The non-transitory computer-readable storage medium of claim 1, wherein the information associated with the plurality of components comprises noise sources associated with the capacitance sensing system.

7. The non-transitory computer-readable storage medium of claim 1, wherein the information associated with the plurality of components comprises a proximity of the capacitance sensing system to other systems.

8. The non-transitory computer-readable storage medium of claim 1, wherein the information associated with the plurality of components comprises physical properties of capacitive sensor elements of the capacitance sensing system.

9. The non-transitory computer-readable storage medium of claim 8, wherein the information associated with the plurality of components comprises one or more substrates on which the capacitive sensor elements are mounted.

10. The non-transitory computer-readable storage medium of claim 1, wherein the processing device is further to:
receive one or more performance requirements for the capacitance sensing system; and
determine whether the capacitance sensing system satisfies the one or more performance requirements based on the simulated performance.

11. The non-transitory computer-readable storage medium of claim 10, wherein the processing device is further to:
in response to determining that the capacitance sensing system does not satisfy the one or more performance requirements, provide an indication of one or more modifications to the capacitance sensing system to enable the capacitance sensing system to satisfy the one or more performance requirements.

12. The non-transitory computer-readable storage medium of claim 1, wherein the simulated performance corresponds to an expected performance of a physical construction of the capacitance sensing system.

13. A capacitance sensing controller comprising:
a memory configured to store a set of configuration parameters, wherein the set of configuration parameters were generated without user intervention based on a simulated performance of a capacitance sensing system and wherein the performance is simulated based on received information associated with a plurality of components of the capacitance sensing system; and
a processing device operatively coupled to the memory and one or more capacitive sensor elements of the capacitance sensing system, wherein the processing device is configured to utilize the set of configuration parameters to measure a capacitance of the one or more capacitive sensor elements.

14. The capacitance sensing controller of claim 13, wherein the received information associated with the plurality of components comprises a mechanical design of the capacitance sensing system.

15. The capacitance sensing controller of claim 13, wherein the received information associated with the plurality of components comprises a user configuration of the capacitance sensing system.

16. The capacitance sensing controller of claim 13, wherein the received information associated with the plurality of components comprises a hardware design of the capacitance sensing system.

17. The capacitance sensing controller of claim 13, wherein the received information associated with the plurality of components comprises circuit information associated with the capacitance sensing system.

18. The capacitance sensing controller of claim 13, wherein the received information associated with the plurality of components comprises noise sources associated with the capacitance sensing system.

19. The capacitance sensing controller of claim 13, wherein the received information associated with the plurality of components comprises a proximity of the capacitance sensing system to other systems.

20. The capacitance sensing controller of claim 13, wherein the received information associated with the plurality of components comprises physical properties of capacitive sensor elements of the capacitance sensing system.

21. The capacitance sensing controller of claim 20, wherein the received information associated with the plurality of components comprises one or more substrates on which the capacitive sensor elements are mounted.
